(19) United States
(12) Patent Application Publication
(10) Pub. No.: US 2022/0223008 A1
(43) Pub. Date: Jul. 14, 2022

(54) DICE GAME DEVICE AND IMAGE DISPLAY METHOD FOR DICE GAME DEVICE

(71) Applicant: SEGA SAMMY CREATION INC., Tokyo (JP)

(72) Inventor: Hiroyuki Miyano, Tokyo (JP)

(21) Appl. No.: 17/612,324

(22) PCT Filed: May 20, 2019
(86) PCT No.: PCT/JP2019/019923

§ 371 Date: Nov. 18, 2021

(51) Int. Cl. G07F 17/32

(52) U.S. Cl. CPC G07F 17/3267; G07F 17/3269; G07F 17/3213

(57) ABSTRACT

A dice game device capable of giving the same fun as card games and enhancing customer attraction. The dice game device 100 includes an image display unit, an image control unit that controls an image to be displayed on the image display unit, and a game computation unit that performs a game computation for a dice game. The image control unit has a function of generating a die image in which one of a plurality of possible outcomes of a die roll appears on at least one face of a die as a result of the game computation by the game computation unit, and a function of changing a display allowable area for the die image.

### CROSS-REFERENCE TO RELATED APPLICATIONS

This application is the U.S. national phase of the International Patent Application No. PCT/JP2019/019923 filed May 20, 2019, the entire content of which is incorporated herein by reference.

### TECHNICAL FIELD

The present disclosure relates to a dice game device and an image display method for the dice game device.

### BACKGROUND

In card games such as baccarat, winning or losing is decided based on symbols and numbers (hereinafter collectively referred to as “suits”) printed on the cards. In such a card game, a so-called “squeezing” is customarily performed in which one player carefully turns up the edge of a card dealt face down from the dealer. For example, Japanese Patent Publication JP-A-2006-223588 discloses a game device that enables such a squeezing action to be virtually displayed as an image on a computer.

Further, there is a dice game in which winning or losing is decided by the outcome of a dice (die) roll. For example, Japanese Patent Publication JP-A-2012-75622 discloses a game device that enables a dice game called Sic Bo to be playable with the assistance of a computer, which is played according to the outcomes of three dice that are blown up and then dropped.

### SUMMARY

Incidentally, the card game device of Japanese Patent Publication JP-A-2006-223588 can provide thrilling fun by simulating an actual squeezing action.

However, in the dice game device of Japanese Patent Publication JP-A-2012-75622, since there is no concept of “squeezing” on the dice in the first place, it has been considered that such a fun as the above-described card game device could not be provided.

Therefore, an object of the present disclosure is to provide a dice game device and an image display method for the dice game device, which are capable of providing the same fun as card games and enhancing customer attraction.

A dice game device according to an embodiment is a dice game device that comprises an image display unit; an image control unit that controls an image to be displayed on the image display unit; and a game computation unit that performs a game computation for a dice game, wherein the image control unit has a function of generating a die image in which one of a plurality of possible outcomes of a die roll appears on at least one face of a die as a result of the game computation by the game computation unit, and a function of changing a display allowable area for the die image.

According to this aspect, a configuration is provided in which the display allowable area where the outcome of a die roll is to be displayed is changed, so that it is possible to give the fun of squeezing in a dice game as in card games. As a result of this, it is possible to enhance the customer attraction to the dice game device.

An image display method for a dice game device according to another embodiment is an image display method for a dice game device that controls an image to be displayed on an image display unit, and performs a game computation for a dice game. The image display method comprises the steps of: generating a die image in which one of a plurality of possible outcomes of a die roll appears on at least one face of a die as a result of the game computation by the game computation unit; and changing a display allowable area for the die image.

According to the disclosed embodiments, it is possible to provide a dice game device and an image display method for the dice game device, which are capable of providing the same fun as card games and enhancing customer attraction.

### BRIEF DESCRIPTION OF THE DRAWINGS

Various embodiments are illustrated in the drawings, in which:

FIG. 1 is an external perspective view of a dice game device according to a first embodiment.

FIG. 2 is a block diagram of the dice game device according to the first embodiment.

FIG. 3 illustrates an example of a game display image of the dice game device according to the first embodiment.

FIG. 4 is a detailed explanatory view of a betting board display area in the dice game device according to the first embodiment.

FIG. 5 is a diagram illustrating how a display allowable area changes in response to a push of an operation input device.

FIG. 6A illustrates a relationship between the timing at which an outcome “1” or “2” of a die roll is predictable and the outcome.

FIG. 6B illustrates a relationship between the timing at which an outcome “3” or “4” of a die roll is predictable and the outcome.

FIG. 6C illustrates a relationship between the timing at which an outcome “5” or “6” of a die roll is predictable and the outcome.

FIG. 7 is a diagram illustrating a relationship between a phase shift of the display allowable area and a game progress.

FIG. 8 is a flowchart illustrating an image display method for the dice game device according to the first embodiment.

FIG. 9 is an explanatory diagram illustrating examples in which the direction of lined-up elements constituting an outcome of a die roll is unified among possible outcomes.

FIG. 10 is an explanatory diagram illustrating examples in which the interval of lined-up elements constituting an outcome of a die roll is unified.

FIG. 11 is an explanatory diagram illustrating examples of a relationship between a phase shift of the display allowable area and a game progress in the case where the direction and interval of lined-up elements constituting an outcome of a die roll are adjusted.

### DETAILED DESCRIPTION

Preferred embodiments are described below with reference to the accompanying drawings.

### Definition

Terms as used herein are defined as follows.

“Chip”: refers to a virtual currency used by a player to express a predicted outcome of a die roll. One “chip” has a certain amount of credits or points.

“Betting board”: refers to a virtual table on which chips are placed to express a player predicted outcome.

“Bet”: refers to expressing a player predicted outcome, specifically, placing chips on the betting board.

“Bet position”: refers to a position where chips are placed on the betting board.

“Bet amount”: refers to a total of credits or points of chips placed at a single bet position. This also refers to a subtotal of bets placed by one player placed at a single bet position, or a total of bets placed by all players placed at the same single bet position.

### First Embodiment

A first embodiment relates to a game device by which Sic Bo is playable. In the game device, dice and others used in Sic Bo are provided as virtual game tools.

### Hardware Configuration Example of Dice Game Device

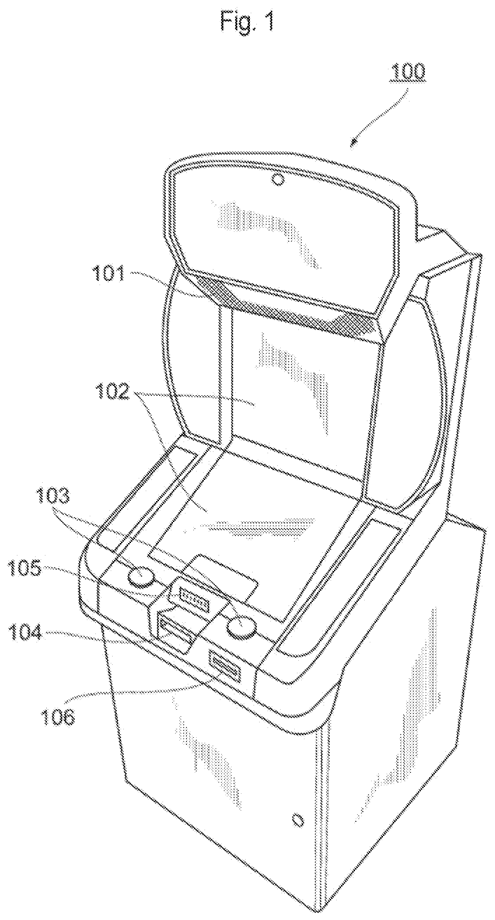

FIG. 1 is an external perspective view of a dice game device according to the first embodiment. A dice game device 100 illustrated by way of example in FIG. 1 is a stand-alone game device installed in a casino, an amusement facility, or the like. In the present embodiment, it is assumed that a player plays Sic Bo with the dice game device 100.

As illustrated in FIG. 1, the dice game device 100 includes a speaker 101, a display device (image display unit) 102, an operation input device 103, a card reading device 104, a bill insertion device 105, and a ticket payout device 106 in appearance.

The speaker 101 is sound output means for outputting voice guidance and effect sound of a game. The display device 102 is display means for displaying images (e.g., still images, moving images, videos, etc.) for expressing or presenting the game. The operation input device 103 is configured to include a plurality of operation buttons, and receives input of an order from a player to the game device via the operation buttons. It is noted that the operation input device 103 is not limited to such a configuration, and any configuration may be adopted as long as the configuration allows the player to input orders, such as a touch panel or an operation stick. The card reading device 104 is a card reader that reads information from a card owned by the player. The bill insertion device 105 is a device that reads inserted bills and tickets. The ticket payout device 106 is ticket output means for paying out a card to the player.

The card to be read by the card reading device 104 is a medium in which gaming information of the player is stored. In the card, for example, points and the like acquired depending on gaming conditions of the player can be additionally stored. The player can obtain various services depending on the information stored in the card, but the contents stored in the card do not affect the gamming result.

Further, the dice game device 100 includes a computing device therein as a control device that totally controls the dice game device 100.

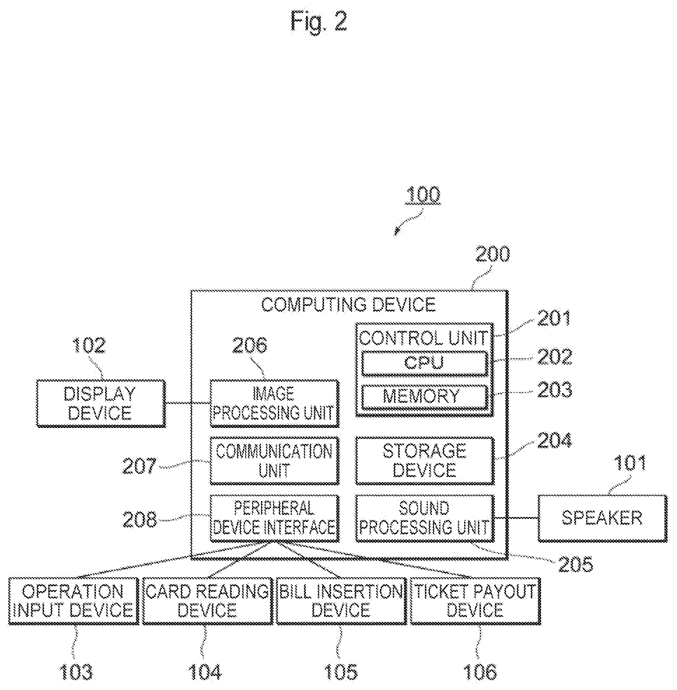

Now with reference to FIG. 2, an example of the hardware configuration of a computing device 200 included inside the dice game device 100 will be described. FIG. 2 is a block diagram of the dice game device according to the first embodiment. As illustrated in FIG. 2, the computing device 200 includes, as a main hardware configuration, a control unit (image control unit, game computation unit) 201, a storage device 204, a sound processing unit 205, an image processing unit 206, a communication unit 207, and a peripheral device interface 208.

The control unit 201 includes a CPU (Central Processing Unit) 202 and a memory 203. The computing device 200 controls processing and operations of another hardware configuration to implement various functions by, for example, executing a predetermined software program (e.g., a game software program) stored in the memory 203 and the storage device 204 by the CPU 202. In other words, under the control of the control unit 201, the computing device 200 implements a game function in cooperation with another hardware by executing a predetermined program. It is noted that FIG. 2 illustrates only the main configuration of the computing device 200, and the computing device 200 also includes other configurations of general information processing devices.

The storage device 204 is composed of a hard disk or the like. In the storage device 204, data reading and writing are performed by the control unit 201. That is, in the storage device 204, data such as a software program necessary for the processing in the computing device 200 is written and data as a result of the processing is written. Under the control of the control unit 201, the sound processing unit 205 performs various sound processing and outputs voice to the speaker 101. Under the control of the control unit 201, the image processing unit 206 performs various graphics processing and outputs an image to the display device 102. The communication unit 207 is an interface enabling communication with a server or another game device. The peripheral device interface 208 is an interface enabling the computing device 200 to communicate with peripheral devices such as the operation input device 103, the card reading device 104, the bill insertion device 105, and the ticket payout device 106.

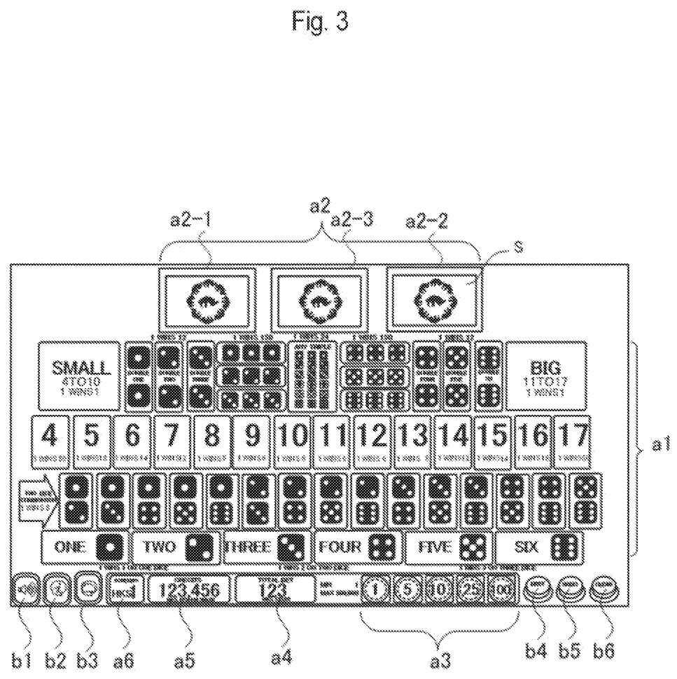

FIG. 3 illustrates an example of a game display image (first display image) displayed on the display device 102 of the dice game device 100 according to the first embodiment. As illustrated in FIG. 3, the first display image includes display areas: a betting board display area a1, a dice display area a2, a betting unit selection area a3, a total bet number display area a4, a credit remaining number display area a5, and a denomination set value display area a6. The control unit (game computation unit, image control unit) 201 performs a game computation for a dice game in response to an input of a game start instruction, and controls the first image to be displayed on the display device 102 based on the result of the game computation.

(a1) The betting board display area a1 is an area where a betting board for a player to directly bet is displayed. Details of the operation for that area will be described later.

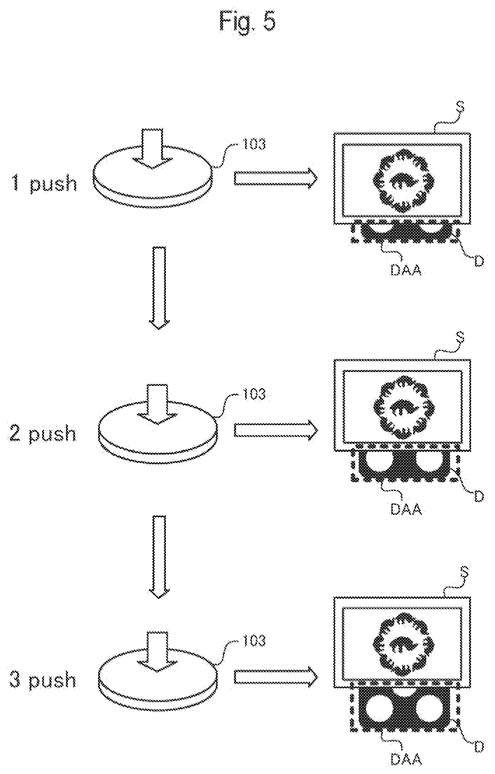

(a2) The dice display area a2 is an area where three rolled dice D are displayed. In the present embodiment, for example, three display areas are set as a left side display field a2-1, a right side display field a2-2, and a center display field a2-3. A display allowable area DAA where one face of a rolled dice D is set in each of the display fields a2-1, a2-2, and a2-3 (see FIG. 5). In the initial state, the display allowable area DAA and the rolled die D are covered with a shield S. The shield S has a function of changing the display allowable area DAA. In the present embodiment, the display allowable areas DAA are changed by moving the shield S side by side in the order of the left side display field a2-1, the right side display field a2-2, and the center display field a2-3, to display the rolled dice D. The order of displaying the rolled dice D is an example, and is not limited to the present embodiment.

(a3) The betting unit selection area a3 is an area where chips that can be operated for betting by the player are displayed. For example, in this area a3, chips in credit units of “1”, “5”, “10”, “25”, and “100” are to be displayed side by side. Preferably, the chips are distinguished by color. For example, “1” is white, “5” is red, “10” is blue, “25” is green, “100” is black, and so on so that what kind of chips it is can be recognized at a glance. It is noted that, when the user touches any chip (e.g., “10”) to select a chip, the chip is enlarged and displayed. This enlarged display makes it possible for the player to visibly recognize which chip the player is selecting.

(a4) The total bet number display area a4 is an area where the total number of credits of chips bet on the betting board in the game is displayed.

(a5) The remaining credit number display area a5 is an area where the total remaining number of credits of the player stored in the dice game device 100 is displayed.

(a6) The denomination set value display area a6 is an area wherein the number of credits allocated to a cash unit set by a manager or clerk of the dice game is displayed. As this denomination set value is made higher, more credits can be earned with a same amount of cash.

Further, as illustrated in FIG. 3, the first display image includes operation buttons to be displayed: a sound button b1, a help button b2, a language selection button b3, a double bet button b4, an undo button b5, and a clear button b6.

(b1) The sound button b1 is an input icon for adjusting the volume from the speaker 101 of the dice game device 100.

(b2) The help button b2 is an input icon for displaying a help document on the display device 102 when an operation of the game device 100 is not understood.

(b3) The language selection button b3 is an input icon for selecting the language used in the display device 102 or the like.

(b4) The double bet button b4 is an input icon to be operated to double the current bet in the bet position. However, if the maximum bet amount displayed in a betting allowable range display area is exceeded as a result of operating that button, the button is disabled.

(b5) The undo button b5 is an input icon to be operated to cancel the operation performed immediately before and return to the previous operation state.

(b6) The clear button b6 is an input icon to be operated to reset all the betting operations that have been performed in the game during the betting period.

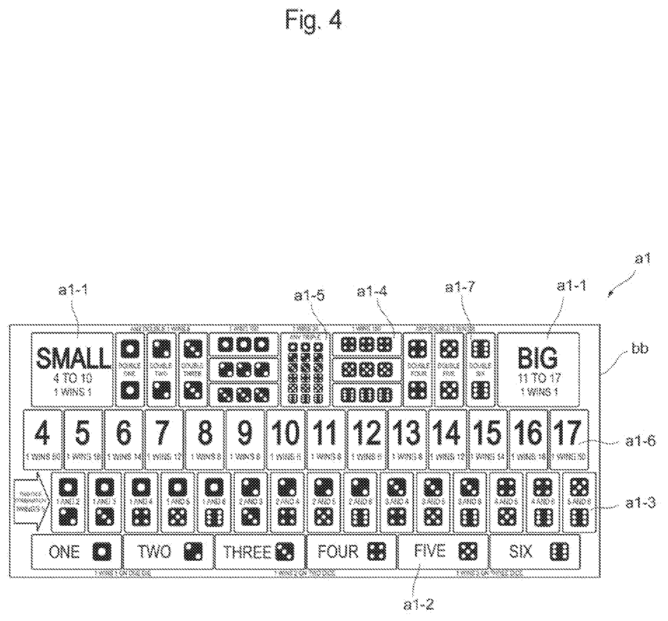

FIG. 4 is a detailed explanatory view of the betting board display area in the dice game device according to the first embodiment. As illustrated in FIG. 4, a betting board bb corresponds to an actual betting board, and includes special areas: Big/Small areas a1-1, Specific Single Dice areas a1-2, Specific Double areas a1-3, Specific Triple areas a1-4, Any Triple area a1-5, Three Dice Total areas a1-6, and Two Dice Combination areas a1-7.

(a1-1) The Big/Small areas a1-1 are areas for betting based on a prediction whether the total of the outcomes of the three rolled dice D is “large/small”. For example, if the player predicts that the total of the outcomes of the three rolled dice D is to be “4 to 10”, the player bets on “Small”, that is, small; if the player predicts that the total of the outcomes of the three rolled dice D is to be “11 to 17”, the player bets on “Big”, that is, big. It is noted that if the outcomes are “same numbers” (e.g., “1, 1, 1”, etc.), it results in losing.

(a1-2) The Specific Single Dice areas a1-2 are areas for betting based on a prediction of the outcome of one of the three rolled dice D (i.e., “single”).

(a1-3) The Specific Double Dice areas a1-3 are areas for betting based on a prediction of the outcome of two of the three rolled dice D (i.e., “double”).

(a1-4) The Specific Triple areas a1-4 are areas for betting based on a prediction in which the outcomes of the three rolled dice D are all the same number (i.e., “triple”) and what number is.

(a1-5) The Any Triple area a1-5 is an area for betting based on a prediction in which the outcomes of the three rolled dice D are all the same number but regardless of the number (i.e., “any triple”).

(a1-6) The Three Dice Total Areas a1-6 are areas for betting based on a prediction of what number the total of the outcomes of the three rolled dice D is (i.e., “total of outcomes”).

(a1-7) The Two Dice Combination areas a1-7 are areas for betting based on a prediction of two of the outcomes of the three rolled dice D (i.e., “combination of two”).

The payout in the first betting board display area a1 described above is preset by a control program of the dice game or the like. For example, the reward for the bet on a Big/Small area a1-1 being won is 1:1 (one payout for one bet; “1 WINS 1”), and the reward for the bet on a Specific Double area a1-3 being won is 1:5; and so on.

Next, a roll effect image in the first embodiment will be described. FIG. 5 is a diagram illustrating how the display allowable area changes in response to an operation of the operation input device 103. As illustrated in FIG. 5, in the present embodiment, the display allowable area DAA is changed by moving the shield S that can cover the whole display area. The dice game device 100 according to the present embodiment includes the operation input device (operation unit) 103, and an operation button is illustrated by way of example of the operation input device (operation unit) 103. The dice game device 100 according to the present embodiment changes the display allowable area DAA by moving the shield S in conjunction with a pressing (push) operation of the operation button 103.

First, as illustrated in FIG. 5, when the operation button 103 is pushed once, the shield S is raised by one step, and a lower end of the face of a rolled die D is displayed in a first step area of the display allowable area DAA. At this phase, the outcome of the rolled die D is narrowed down to any of 4, 5, and 6.

When the operation button 103 is further pushed once (twice in total), the shield S is raised by two steps in total, and a lower end of the face of the rolled die D is displayed in a second step area of the display allowable area DAA. Even at this phase, the outcome of the rolled die D is any of 4, 5, and 6. When the operation button 103 is further pushed once (three times in total), the shield S is raised by three steps in total, and a half of the face of the rolled die D is displayed in a third step area of the display allowable area DAA. At this phase, it is found that the outcome of the rolled die D is 5.

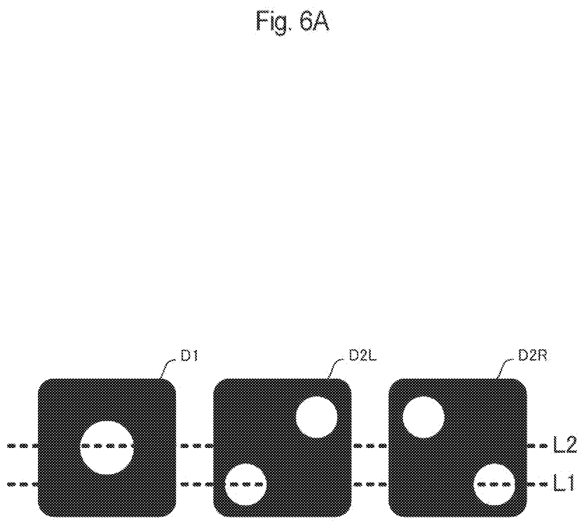

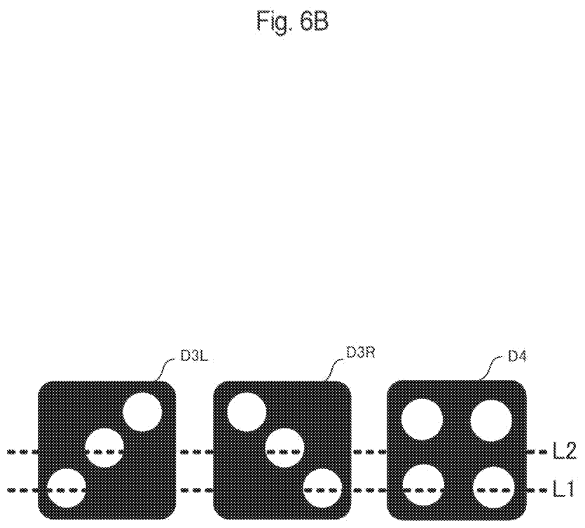

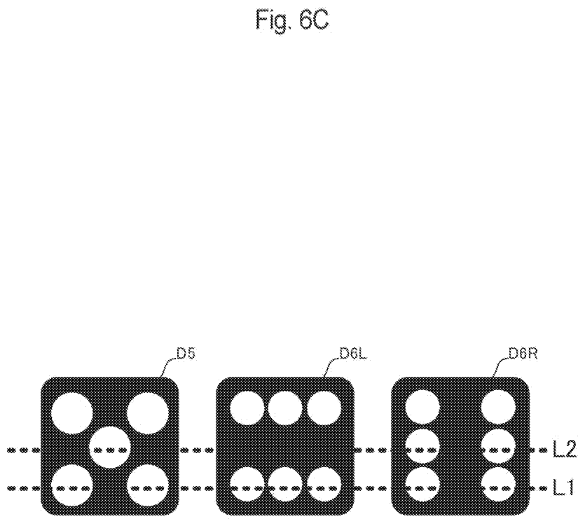

Next, the timing at which the outcome becomes predictable will be described. FIG. 6A illustrates a relationship between the timing at which an outcome “1” or “2” of a die roll is predictable and the outcome. As illustrated in FIG. 6A, for the outcome “1”, D1, no element of the outcome is displayed in a first phase L1 of the display allowable area, and thus it is predictable as an outcome “1”. The outcome “2” has two possible arrangements: 2-left side D2L and 2-right side D2R. The 2-left side D2L and the 2-right side D2R have no difference between an outcome “2” and an outcome “3” in the first phase L1 of the display allowable area, but are predictable as an outcome “2” in a second phase L2.

FIG. 6B illustrates a relationship between the timing at which an outcome “3” or “4” of a die roll is predictable and the outcome. As illustrated in FIG. 6B, the outcome “3” has two possible arrangements: 3-left side (first side) D3L and 3-right side (second side) D3R. The 3-left side D3L and the 3-right side D3R have no difference between an outcome “2” and an outcome “3” in the first phase L1 of the display allowable area, but are predictable as an outcome “3” in the second phase L2. Further, the outcome “4”, D4, has no difference among an outcome “4”, an outcome “5”, and an outcome “6” in the first phase L1 of the display allowable area, but is predictable as an outcome “4” in the second phase L2.

FIG. 6C illustrates a relationship between the timing at which an outcome “5” or “6” of a die roll is predictable and the outcome. As illustrated in FIG. 6C, the outcome “5”, D5, has no difference among an outcome “4”, an outcome “5”, and an outcome “6” in the first phase L1 of the display allowable area, but are predictable as an outcome “5” in the second phase L2. Further, the outcome “6” has two possible arrangements: 6-left side (first side) D6L and 6-right side (second side) D6R. The 6-left side D6L is predictable as an outcome “6” in the first phase L1 of the display allowable area. The 6-right side D6R has no difference among an outcome “4”, an outcome “5”, and an outcome “6” in the first phase L1 of the display allowable area, but is predictable as an outcome “6” in the second phase L2. It is noted that, in FIGS. 6A to 6C, it is preferable to display the whole outcome of a die roll, without a push operation of the operation button 103, at the timing at which the outcome is predictable based on the display allowable area.

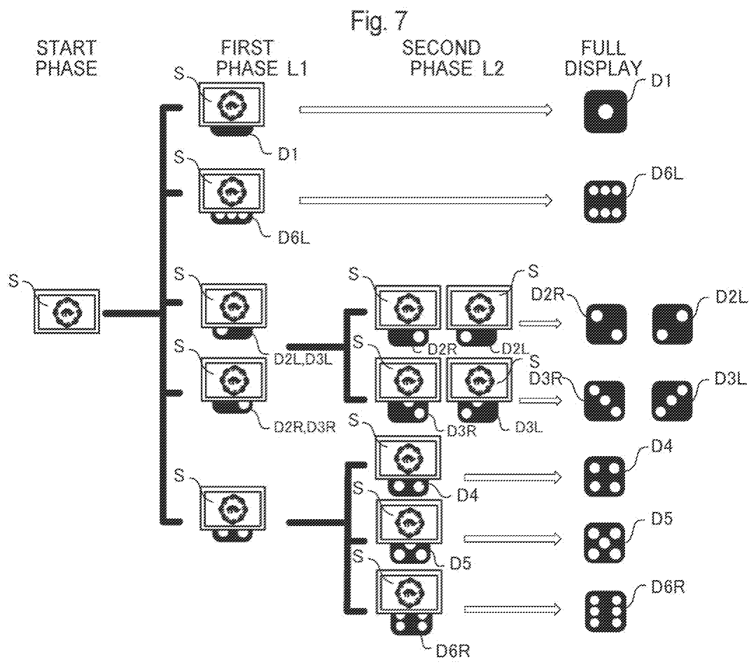

Next, a change in the display allowable area and a game progress will be described. FIG. 7 is a diagram illustrating a relationship between a phase shift of the display allowable area and a game progress. As illustrated in FIG. 7, the outcome of a die roll has different phases in which it is predictable depending on the change phase of the display allowable area. In the present embodiment, the whole outcome is displayed at the timing at which the outcome of the die roll is predictable based on the display allowable area.

At a start phase, the shield S covers the entire face of a die. The outcome “1”, D1, is predictable as an outcome “1” because no suit is displayed in the first phase L1 of the display allowable area. Thus, for the outcome “1”, the outcome is fully displayed without a shift to the second phase L2 of the display allowable area. The left side D6L of the outcome “6” is predictable as an outcome “6” in the first phase L1 of the display allowable area. Thus, for the left side D6L of the outcome “6”, the outcome is fully displayed without a shift to the second phase L2 of the display allowable area.

The left side D2L of the outcome “2” and the left side D3L of the outcome “3” have no difference between an outcome “2” and an outcome “3” in the first phase L1 of the display allowable area. Similarly, the right side D2R of the outcome “2” and the right side D3R of the outcome “3” have no difference between an outcome “2” and an outcome “3” in the first phase L1 of the display allowable area. The left side D2L and right side D2R of the outcome “2” are predictable as an outcome “2” in the second phase L2 of the display allowable area. Similarly, the left side D3L and right side D3R of the outcome “3” are predictable as an outcome “3” in the second phase L2 of the display allowable area. Thus, for the outcome “2” and the outcome “3”, the display allowable area is shifted to the second phase L2, and then the outcome is fully displayed.

The outcome “4”, D4, the outcome “5”, D5, and the right side D6R of the outcome “6” have no difference among an outcome “4”, an outcome “5”, and an outcome “6” in the first phase L1 of the display allowable area. In the second phase L2 of the display allowable area, the outcome “4”, D4, the outcome “5”, D5, and the right side D6R of the outcome “6” are predictable. Thus, for the outcome “4”, D4, the outcome “5”, D5, and the right side D6R of the outcome “6”, the display allowable area is shifted to the second phase L2, and then the outcome is fully displayed.

In this way, with the dice game device 100 according to the first embodiment, the timing at which the outcome of a die roll is predictable based on the display allowable area is preferably the time when the presence or absence of elements lined up along a first side set on one face of the die is known, or the time when the number of elements lined up along the first side is known. Further, the timing is preferably the time when the presence or absence of elements lined up along a second side parallel to the first side is known, or the time when the number of elements lined up along the second side is known.

### Operations of Game Device and Image Display Method According to First Embodiment

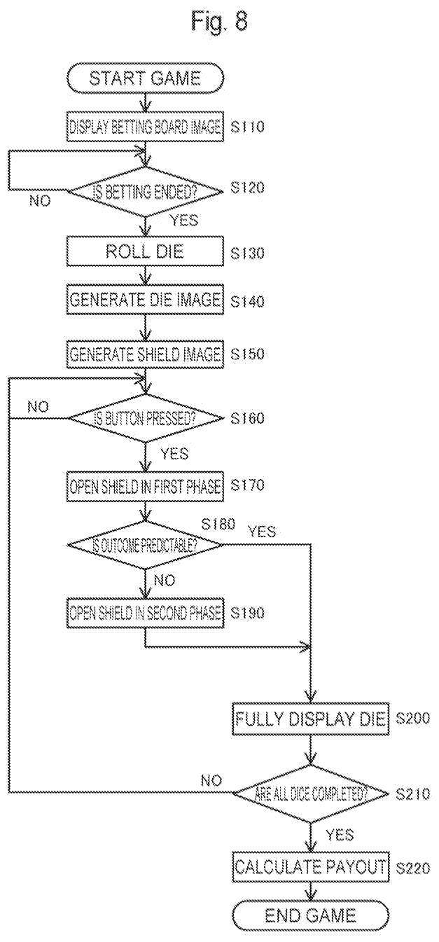

Next, with reference to FIGS. 5 and 8, the operations of the dice game device 100 according to the first embodiment will be described, and an image display method for the dice game device 100 according to the first embodiment will also be described. The image display method for the dice game device 100 according to the first embodiment is an image display method in which a virtual game tool (Sic Bo) is dynamically changed to produce and display a result of drawing. This image display method includes the steps of, by the dice game device (image control unit) 100, generating a die image in which one of a plurality of possible outcomes of a die roll appears on at least one face of a die as a result of a game computation; and changing a display allowable area for the die image. Hereinafter, the image display method will be described in detail.

FIG. 8 is a flowchart illustrating the image display method for the dice game device according to the first embodiment. As illustrated in FIG. 8, when a game is started in the dice game device 100, first, the control unit 201 of the computing device 200 generates a betting board image by the image processing unit 206, and displays the betting board image as a view image on the display device 102 (S110).

Next, the control unit 201 determines whether or not betting is completed at any bet position in the betting board display area a1 (S120). When the control unit 201 determines that betting is not completed yet (S120/NO), the control unit 201 waits until the betting is completed. When the control unit 201 determines that the betting is completed (S120/YES), the control unit 201 enters drawing processing (S130).

After performing the drawing processing, the control unit 201 of the computing device 200 generates a die image by the image processing unit 206 (S140), generates a shield image (S150), and displays the shield image on the die image. In this way, the dice game device 100 according to the first embodiment has a function of executing a drawing to determine the outcome of a die D.

Next, the control unit 201 determines the push (i.e., pressing) of the operation button 103 (S160).

When the control unit 201 determines that the operation button 103 is not pressed (S160/NO), the control unit 201 waits until the operation button 103 is pressed. When the control unit 201 determines that the operation button 103 is pressed (S160/YES), the control unit 201 opens the shield S in the first phase in the left side display field a2-1 of the dice display area a2 (S170).

The control unit 201 determines whether or not the outcome of the rolled die D is predictable in the first phase (S180). If the outcome of the rolled die D is predictable in the first phase, the processing proceeds to step S200. If the outcome of the rolled die D is not predictable in the first phase, the shield S is opened in the second phase (S190), and the processing proceeds to step S200.

In step S200, the shield S is fully opened to fully display the outcome of the rolled dice D. Next, the control unit 201 determines whether or not the outcomes of all the rolled dice D are fully displayed (S210). When the control unit 201 determines that a rolled die D to be displayed (e.g., the die on the right side) remains (S210/NO), the control unit 201 determines whether or not the operation button 103 is pressed (S160) as described above. When the operation button 103 is pressed, the control unit 201 opens the shield S in the first phase in the right side display field a2-2 of the dice display area a2 (S170). After that, the control unit 201 sequentially performs the steps from step S180 to step S200.

After that, when the control unit 201 determines that all the rolled dice D are displayed (S210/YES), the control unit 201 performs the display for winning and processing of payout calculation (S220). After the payout processing is performed, the dice game ends. In this way, the dice game device 100 according to the first embodiment has a function of sequentially changing the display allowable areas of dice images for a plurality of dice and then performing the processing of payout calculation.

As described above, the dice game device 100 according to the first embodiment is configured to change the display allowable area where the outcome of a die roll is displayed. Therefore, according to the dice game device 100 of the first embodiment, it is possible to give the fun of “squeezing” in a dice game as in card games, and it is thus possible to enhance the customer attraction to the dice game device 100.

Further, since the display allowable area is changed by moving the shield that can cover the face of a die (i.e., the die image), it is possible to give the fun of the squeezing operation as in card games.

Further, the dice game device 100 according to the first embodiment includes an operation button serving as the operation input device (operation unit) 103, and changes the display allowable area in conjunction with a push operation on the operation button. Therefore, the dice game device 100 according to the first embodiment makes it possible for the player to perform the squeezing operation.

In addition, the dice game device 100 according to the first embodiment displays the whole outcome of a rolled die at the timing at which the outcome is predictable based on the display allowable area, so that the player can be prevented from feeling the sluggishness that the operation is useless.

The timing of the full display is either one of the time when the presence or absence of elements lined up along the first side set on one face or the number of elements lined up along the first side is known, and the time when the presence or absence of elements lined up along the second side parallel to the first side or the number of elements lined up along the second side is known. Thus, the dice game device 100 according to the first embodiment displays the whole outcome of a rolled die at an appropriate timing, so that the player can be prevented from feeling the sluggishness that the operation is useless.

### Second Embodiment

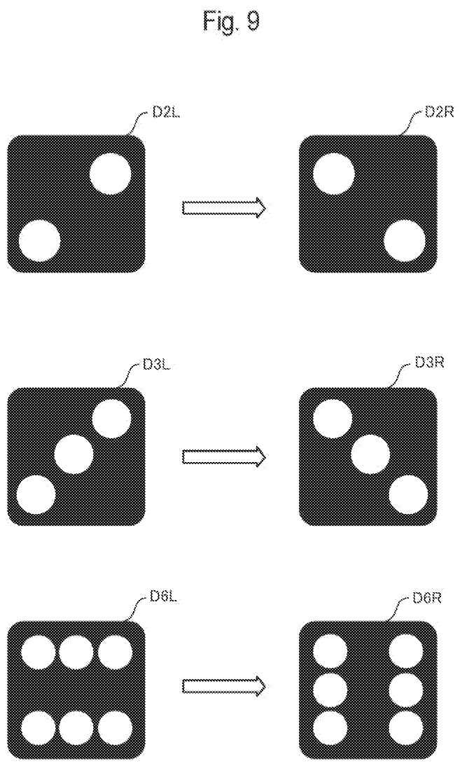

Next, a second embodiment will be described with reference to FIGS. 9 to 11. The second embodiment is different from the first embodiment in that the direction and interval of lined-up elements constituting an outcome of a die roll are adjusted.

FIG. 9 is an explanatory diagram illustrating examples in which the direction of lined-up elements constituting an outcome of a die roll is unified among possible outcomes. As illustrated in FIG. 9, for a plurality of possible outcomes of a die roll, the direction of lined-up elements constituting each outcome is unified. Specifically, among the left side D2L of the outcome “2”, the left side D3L of the outcome “3”, and the left side D6L of the outcome “6”, the direction of lined-up elements constituting each outcome is unified. In addition, among the right side D2R of the outcome “2”, the right side D3R of the outcome “3”, and the right side D6R of the outcome “6”, the direction of lined-up elements constituting each outcome is unified. This unified direction of lined-up elements constituting each of the plurality of possible outcomes makes it difficult to predict the outcome, especially the outcome “2” or the outcome “3”, in the first phase of the display allowable area.

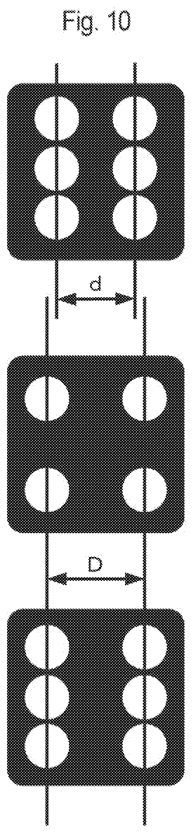

Further, FIG. 10 is an explanatory diagram illustrating examples in which the interval of lined-up elements constituting an outcome of a die roll is unified. As illustrated in FIG. 10, for a plurality of possible outcomes of a die roll, the interval of lined-up elements constituting each outcome is unified. Specifically, if an interval D between the vertical rows constituting the outcome “4” of a die roll and an interval D between the vertical rows constituting the outcome “6” of a die roll are unified, it is difficult to predict the outcome in the first phase of the display allowable area. However, if the interval D between the vertical rows constituting the outcome “4” of a die roll and the interval D between the vertical rows constituting the outcome “6” of a die roll are different, the different interval results in a prediction of the outcome even in the first phase of the display allowable area.

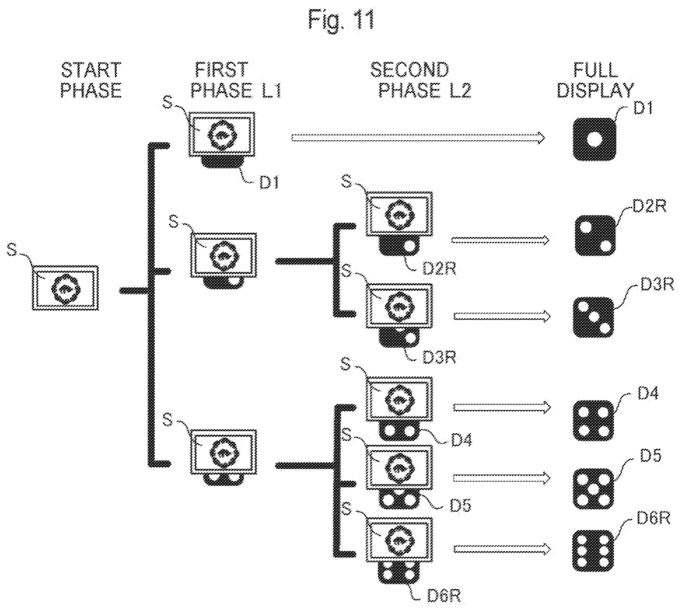

Further, FIG. 11 is an explanatory diagram illustrating examples of a relationship between a phase shift of the display allowable area and a game progress in the case where the direction and interval of lined-up elements constituting an outcome of a die roll are adjusted. As illustrated in FIG. 11, the outcome of a die roll has different phases in which it is predictable depending on the change phase of the display allowable area. In the second embodiment as well as in the first embodiment, it is preferable to display the whole outcome of a die roll at the timing at which the outcome is predictable based on the display allowable area.

At a start phase, the shield S covers the entire face of a die. The outcome “1”, D1, is predictable as an outcome “1” because no element of the outcome is displayed in the first phase L1 of the display allowable area. Thus, for the outcome “1”, the outcome is fully displayed without a shift to the second phase L2 of the display allowable area.

The right D2R of the outcome “2” and the right side D3R of the outcome “3” have no difference between an outcome “2” and an outcome “3” in the first phase L1 of the display allowable area. The right D2R of the outcome “2” is predictable as an outcome “2” in the second phase L2 of the display allowable area. Similarly, the right side D3R of the outcome “3” is predictable as an outcome “3” in the second phase L2 of the display allowable area. Thus, for the right D2R of the outcome “2” and the right side D3R of the outcome “3”, the display allowable area is shifted to the second phase L2, and then the outcome is fully displayed.

The outcome “4”, D4, the outcome “5”, D5, and the right side D6R of the outcome “6” have no difference among an outcome “4”, an outcome “5”, and an outcome “6” in the first phase L1 of the display allowable area. In the second phase L2 of the display allowable area, the outcome “4”, D4, the outcome “5”, D5, and the right side D6R of the outcome “6” are predictable. Thus, for the outcome “4”, D4, the outcome “5”, D5, and the right side D6R of the outcome “6”, the display allowable area is shifted to the second phase L2, and then the outcome is fully displayed.

As described above, the dice game device according to the second embodiment adjusts the direction and interval of lined-up elements constituting the outcome of a die roll. Therefore, the dice game device according to the second embodiment has an advantageous effect that the predicted choices in the case where the squeezing is introduced into the dice game can be simplified.

The embodiments described above are for facilitating the understanding of the present disclosure, and are not intended to limit the present disclosure. The components included in the embodiments and their arrangement, material, condition, shape, size, and the like are not limited to those illustrated, and can be changed as appropriate. Further, the configurations presented in different embodiments can be partially replaced or combined.

For example, the shield S may be continuously (e.g., steplessly) moved in response to a user's push operation without moving the shield S stepwise. Further, the speed at which the shield S is moved may be set to various speeds.

Further, when a plurality of shields S are sequentially moved, the display may be changed by changing the color of each shield S (e.g., flashing in red) so that the user can recognize the shield S to be operated.

Further, there may be a plurality of ways to move the shield S. For example, there may be a method of moving the shield S slowly to perform the squeezing and a method of moving the shield S quickly, so that the user can select the method. As an example, when the user touches the shield S, the outcome of a die roll may be displayed without squeezing.

### LIST OF REFERENCE NUMERALS

100 Dice game device
200 Computing device
D Die
DAA Display allowable area
S Shield

1. A dice game device comprising:
an image display unit;
an image control unit that controls an image to be displayed on the image display unit; and
a game computation unit that performs a game computation for a dice game, wherein
the image control unit has
a function of generating a die image in which one of a plurality of possible outcomes of a die roll appears on at least one face of a die as a result of the game computation by the game computation unit, and
a function of changing a display allowable area for the die image.

2. The dice game device according to claim 1, wherein the image control unit changes the display allowable area by moving a shield that covers the die image.

3. The dice game device according to claim 1, further comprising an operation unit, wherein the image control unit changes the display allowable area in conjunction with an operation on the operation unit.

4. The dice game device according to claim 1, wherein the image control unit displays a whole outcome of the die roll at a timing at which the outcome is predictable based on the display allowable area.

5. The dice game device according to claim 4, wherein the timing is either one of a time when the presence or absence of elements lined up along a first side set to the die image or the number of elements lined up along the first side is known, and a time when the presence or absence of elements lined up along a second side parallel to the first side or the number of elements lined up along the second side is known.

6. The dice game device according to claim 1, wherein the image control unit unifies a direction of lined-up elements constituting each outcome to be displayed among the plurality of possible outcomes.

7. The dice game device according to claim 1, wherein the image control unit displays an image in which an interval of lined-up elements constituting each outcome is unified among the plurality of possible outcomes.

8. The dice game device according to claim 1, wherein the image control unit displays a plurality of die images and generates images in which display allowable areas for the die images sequentially change.

9. An image display method for a dice game device that controls an image to be displayed on an image display unit, and performs a game computation for a dice game, the image display method comprising the steps of:
generating a die image in which one of a plurality of possible outcomes of a die roll appears on at least one face of a die as a result of the game computation by the game computation unit; and
changing a display allowable area for the die image.
